(19) United States
(12) Patent Application Publication
(10) Pub. No.: US 2025/0227086 A1
(43) Pub. Date: Jul. 10, 2025

(54) Your Genesis_24HWS-Based Multi-System Sovereign Domain Engine for Every Person, Every Domain, Every Time

(71) Applicant: FURONG BEI, SAN GABRIEL, CA (US)

(72) Inventor: FURONG BEI, SAN GABRIEL, CA (US)

(21) Appl. No.: 19/094,730

(22) Filed: Mar. 28, 2025

(51) Int. Cl. H04L 61/4505; G06F 21/10; G06Q 30/04; H04L 9/00

(52) U.S. Cl. CPC H04L 61/4505; G06F 21/1014; G06Q 30/04; H04L 9/50

(57) ABSTRACT

This invention introduces a multi-system, multi-dimensional architecture based on over 800 systemized top-level domains that represent global nations, industries, time units (year, month, day, hour), alphabetical classes (A-Z), cities, and interest-based categories. Each domain functions as a sovereign economic and governance system, enabling every person to own personalized digital assets (MainDomainTokens™), generate unlimited subdomains, and participate in decentralized identity, token utility, and DAO governance. The invention further integrates smart contract systems for usage metering (UsageMeter.sol), protocol-driven mapping (TokMap Protocol™), and inheritance logic, creating a perpetual resource engine and ownership structure. Centralized at 24HWS.com and established since 1999, this network provides sovereign entry points and infinite expansion for individuals, families, industries, and nations.

### GENESIS DECLARATION

“Your Genesis is not merely a digital entry. It is a sovereign life extension—a living, breathing mirror of your time, interest, identity, and economic agency. Through your domain, you do not log into someone else's system. You activate your own.”

This declaration serves as the philosophical and structural foundation of the present invention. The proposed system is not merely a technical solution, but a sovereign digital-economic architecture designed to empower every individual with the capacity to initiate, govern, and extend their own realm of digital identity, resource ownership, and time-based value creation. The invention herein is rooted in this ethos of self-sovereignty, dynamic identity, and domain-native agency.

In contrast to conventional platforms that classify individuals as “users” or “subscribers,” this system redefines every human being as an autonomous owner—one who generates value not through participation in another's economy, but through the governance of their own.

Each domain is not simply a website, but a sovereign universe—a programmable, inheritable, and infinitely expandable resource capsule. Domains become time-bound vaults of legacy, containers of identity, and engines of sustainable wealth.

This invention builds a digital foundation where names are not assigned, but chosen; access is not rented, but owned; and every interaction—whether social, economic, or existential—is cryptographically recorded, governed, and extended across generations.

Your Genesis is your key, your kingdom, and your continuity. From it emerges not only a system, but a civilization—one domain at a time.

### 1. FIELD OF THE INVENTION

The present invention relates to decentralized digital infrastructure, sovereign ownership systems, and programmable domain-based economies. More specifically, it provides a global framework for multi-system integration, allowing individuals, organizations, and governments to register, govern, and expand personalized digital identities and ecosystems using top-level domains, smart contracts, and time-linked protocols.

### 2. BACKGROUND OF THE INVENTION

Since 1999, efforts have been underway to construct a universal, self-replicating, and ownership-based internet structure. Existing platforms treat individuals as “users” under centralized control, monetizing attention without granting resource ownership. This invention aims to abolish the user-subscription model and replace it with a sovereign ownership model where each individual, family, industry, and nation becomes the creator, owner, and governor of their own digital universe. Ownership includes naming rights, subdomain control, and autonomous digital economies. The invention introduces a foundational registry of over 800 sovereign domain systems, each capable of infinite expansion. These systems are anchored to the core protocol, TokMap Protocol™, enabling smart contracts, identity tokens (NFTs), and multi-system interactions.

### 3. SUMMARY OF THE INVENTION

This invention defines:
A multi-system, multi-dimensional digital architecture powered by 800+ sovereign top-level domains.
A unified protocol (TokMap Protocol™) for subdomain generation, token issuance, and governance automation.
A decentralized, sovereign system for every person, family, industry, and nation to build and govern digital assets.
A perpetual system of ownership-based domain subdivision, NFT issuance, usage metering, and DAO-based governance.
A time-based identity economy that tokenizes individual temporal data from birth to legacy across year/month/day/hour dimensions.

### 4. SYSTEM ARCHITECTURE

4.1 Multi-System Foundation 800+ sovereign top-level domains form the modular backbone of the system. Each domain represents a core system aligned with one of the following:
Nations (e.g., mexicook.com, indiaok.com, usok.com)
Industries (e.g., ATMS.com, usdao.com, medicalcenter.us)
A-Z Classifications (e.g., 24ho.com, arobot.us)
Time-Based Domains (e.g., hours.us, days.us, week.us)
Cities and Regions (e.g., cnstate.com, cnwuxi.com)
Cultural/Interest-Based (e.g., 36ji.com, SZBF.com, entertainment.us)

Each domain is both independent and integrable, enabling infinite cross-system interaction.

4.2 Multi-Dimensional Layering Each system exists simultaneously across these sovereign dimensions:
Territorial (countries, regional unions, cities)
Industrial (global industries and professions)
Alphabetical (A-Z)
Temporal (year, month, day, hour)
Interest-Based (communities, fields)
Cultural/Traditional (legacy systems)
   4.3 Multi-Cellular Expansion Each top-level domain node generates infinite subdomains that are:
Minted as NFTs (MainDomainToken)
Governed by DAOs (SimpleDAO.sol)
Measured via UsageMeter.sol for metered access and cost-sharing
Mapped via TokMapRegistry.sol for permissionless function linking

### 4.4 Sovereign Core+Federated Nodes

Central Core: 24HWS.com acts as the universal root and interface layer.
Federated Sovereignty: Each domain node is independently governed and may mirror or interact via cross-contract logic.
All systems link to the TokMap Protocol™ but operate autonomously with full subdomain sovereignty.
   4.5 Cross-System Interoperability and Core Constellation The system is designed to enable cross-system interaction between all 800+ sovereign domain nodes, with the following integration layers:
Smart Contract Bridges: Inter-domain communication and token swap across top-level domains using smart contract modules.
TokMap Protocol™ Registry: Each domain maps to a shared TokMapRegistry enabling functional reuse, identity routing, and economic standardization.
NFT Identity Binding: Subdomains and user resources are cryptographically linked to NFT-bound sovereign identity (MainDomainToken ERC-721).
Federated Token Governance: While each domain maintains independent economic control, governance policies can be federated through voting and DAO consensus.
Canvas Constellation View: A multi-dimensional visualization layer illustrates interconnections, ownership layers, and expansion potential of each sovereign domain node.

### 4.6 Life Value Integration and the Time Accumulation Engine

Time is treated not just as chronology, but as an economic and existential dimension.
Temporal Anchoring: Each domain entry may be bound to a specific time point (e.g., 2025.03.27.days.us), representing events, memories, data, and governance changes.
Time Vault System: Each user can accumulate their digital life record through time-bound subdomains, creating perpetual archives of their contributions and legacy.
TimeToken Economy: Time-based tokens may be minted from accumulated actions or services, becoming tradable units of value across the network.
Time-of-Time Sovereignty: Enables universal alignment between time, resources, identity, and tokens.
   4.7 Universal Ownership Model and Token Rights All domain entries created under this system obey a three-tier ownership model:
Main Ownership (MDT NFT): Grants full control of the root domain node.
Subdomain Rights: Users can register unlimited subdomains with usage-based pricing or DAO-based allocations.
Token Binding: Domains can issue fungible or non-fungible tokens, enabling governance, access control, and marketplace utility. Each token/domain entry is transferable, inheritable, revenue-generating, and governed by smart contracts.
   4.8 Ecosystem Access and DAO Infrastructure Access to the ecosystem occurs via:
Personal Domains (e.g., alice.24hws.com)
Nation Domains (e.g., japanok.com)
Industry Domains (e.g., wtocn.com)
Temporal Domains (e.g., 2024.03.27.years.us)
Interest-Based Domains (e.g., cnktv.com) Each domain may instantiate its own:
DAO using SimpleDAO.sol
Payment infrastructure using UsageMeter.sol
NFT-based registry using MainDomainToken.sol
Onboarding via Airdrop or Token Gating

### APPENDIX A

### Systemized List of 800+ Sovereign Domain Structures Under the 24HWS Protocol

This appendix presents the structured domain system forming the backbone of the invention, including territorial, industrial, temporal, alphabetical, and interest-based sovereign domains integrated under the TokMap Protocol™ and powered by 24HWS.

| | | |
|---|---|---|
| 110coin.com | cnbad.com | diponetwork.com |
| 110tv.com | cnbanks.com | diponft.com |
| 120-coin.com | cnbeg.com | dipopay.com |
| 120.us | cnblend.com | dipopro.com |
| 120bank.com | cnbwb.com | diposervices.com |
| 120bank.org | cnbyt.com | dipotk.com |
| 120banks.com | cncah.com | dipotoken.com |
| 120coin.org | cncarpet.com | dipotoken.org |
| 120coin.us | cncbm.com | dipotokens.com |
| 120coins.com | cncharm.com | dipotrade.com |
| 120moneys.com | cnchd.com | dipoventures.com |
| 120token.com | cncod.com | dipow3.com |
| 12hws.com | cncollege.com | dipowallet.com |
| 168bank.com | cncopy.com | dipoworld.com |
| 168radio.com | cncty.com | dnewera.com |
| 168tv.com | cncwb.com | doctoraidomains.com |
| 1888p.com | cndaj.com | doctoraiglobal.com |
| 18hws.com | cndmd.com | doctoraitokens.com |
| 1g888.com | cndoe.com | dpaysystem.com |
| 20hws.com | cndoor.com | draiins.com |
| 21hws.com | cndove.com | draitechs.com |
| 22hws.com | cndrugs.com | draitoken.com |
| 238.us | cndrv.com | draitoken.org |
| 23hws.com | cnebm.com | drugscn.com |
| 24-hws.com | cnedr.com | dworld2030.com |
| 247hws.com | cnedu.com | e8889.com |
| 247hwstoken.com | cnefm.com | eages.com |
| 24eco24.com | cnege.com | educationw3.com |
| 24eco4u.com | cneim.com | eduog.com |
| 24econet.com | cnejy.com | egyptok.com |
| 24econex.com | cnevt.com | emotiondex.com |
| 24hact.com | cneww.com | energyw3.com |
| 24hboat.com | cneyp.com | ent.us |
| 24hdrive.com | cnfaq.com | entertainments.us |
| 24hds.com | cnfarm.com | entertainmentw3.com |
| 24hjet.com | cnfcy.com | famoustea.com |
| 24hjets.com | cnfeb.com | finlandok.com |
| 24hlog.com | cnfilm.com | foodcn.com |
| 24hmedical.com | cnflag.com | frbei.com |
| 24hns.com | cnfloor.com | fridayweb.com |
| 24ho.com | cnfnd.com | fubanks.com |
| 24hour.us | cnfsa.com | fucurrency.com |
| 24hoursws.com | cnftid.com | furongbei.com |
| 24hourws.com | cnfwt.com | germanyok.com |
| 24hrs.us | cnfwy.com | globalw3dao.com |
| 24hrws.com | cngbg.com | greeceok.com |
| 24hserve.com | cngfs.com | gs888.com |
| 24hstock.com | cnggo.com | guangyincoin.com |
| 24hstoken.com | cngib.com | gx888.com |
| 24hstokens.com | cngig.com | gz888.com |
| 24hstream.com | cngip.com | h24ws.com |
| 24htoken.com | cngoing.com | ha888.com |
| 24hwaste.com | cngow.com | hainanchina.com |
| 24hwater.com | cngrl.com | happyusa.com |
| 24hwest.com | cngwe.com | he888.com |
| 24hws.agency | cngws.com | hn888.com |
| 24hws.app | cnhad.com | hours.us |
| 24hws.art | cnhgo.com | hungaryok.com |
| 24hws.biz | cnhire.com | hwstoken.com |
| 24hws.blog | cnhoe.com | hyjy.com |
| 24hws.cloud | cnhold.com | i8882.com |
| 24hws.club | cnhomes.com | i8887.com |
| 24hws.com | cnhospitals.com | icoach.us |
| 24hws.digital | cnhouses.com | idamages.com |
| 24hws.homes | cnhsp.com | ilegendary.org |
| 24hws.info | cnhwb.com | ilegendarys.com |
| 24hws.it.com | cniai.com | indiaok.com |
| 24hws.life | cnieo.com | indonesiaok.com |
| 24hws.live | cnifm.com | inftid.com |
| 24hws.me | cnify.com | inscn.com |
| 24hws.net | cnihi.com | iranok.com |
| 24hws.online | cniix.com | iraqok.com |
| 24hws.org | cnila.com | irelandok.com |
| 24hws.pro | cnily.com | italyok.com |
| 24hws.services | cnimk.com | japanok.com |
| 24hws.shop | cnioi.com | l5888.com |
| 24hws.site | cnitd.com | latamw3.com |
| 24hws.space | cnitg.com | lifebankers.com |
| 24hws.store | cniwd.com | lifebankline.com |
| 24hws.us | cniym.com | lifebanklive.com |
| 24hws.vip | cnjbs.com | lifebankloans.com |
| 24hws.work | cnjnt.com | lifebanks.org |
| 24hws.world | cnkim.com | lifecoinprotocol.com |
| 24hws.ws | cnktv.com | lifetimeblock.com |
| 24hws.xyz | cnlem.com | lifetimecoin.org |
| 24hwsa.com | cnlev.com | lifetimecoinbank.com |
| 24hwscoin.com | cnlew.com | lifetimecryptocoin.com |
| 24hwscoins.com | cnlip.com | lifetimenft.com |
| 24hwsdao.com | cnloans.com | lifetimetokens.com |
| 24hwshub.com | cnlocks.com | lifetimewallet.com |
| 24hwsid.com | cnlof.com | lightcoinpay.com |
| 24hwslab.com | cnlong.com | lightsilvercoin.com |
| 24hwsnft.com | cnlots.com | livecn.com |
| 24hwsnow.com | cnlov.com | livesbanks.com |
| 24hwstime.com | cnlover.com | ln888.com |
| 24hwstoken.com | cnloy.com | maindomaintoken.com |
| 24hwstoken.net | cnlrn.com | malaysiaok.com |
| 24hwstoken.org | cnmagazines.com | maneydao.com |
| 24hwstoken.us | cnmcm.com | manufacturew3.com |
| 24hwstokens.com | cnmedical.com | mdtdao.com |
| 24hwsw.com | cnmel.com | medias.us |
| 24hwsw3.com | cnmhi.com | medicalcenter.us |
| 24hwtoken.com | cnmks.com | medicalw3.com |
| 24swo.com | cnmmi.com | medprc.com |
| 24talkx.com | cnmof.com | mexicook.com |
| 24talkz.com | cnmoh.com | netherlandsok.com |
| 24tkai.com | cnmou.com | newzealandok.com |
| 24tken.com | cnmoving.com | nftdao.us |
| 24tkex.com | cnmoy.com | nftid.org |
| 24tkid.com | cnmte.com | nftid.us |
| 24tknet.com | cnmtm.com | nftlin.com |
| 24tkon.com | cnmyj.com | nigeriaok.com |
| 24tkval.com | cnnaw.com | nm888.com |
| 24tokdao.com | cnned.com | norwayok.com |
| 24tokeco.com | cnnfa.com | nx888.com |
| 24tokeconomy.com | cnngb.com | oncologys.com |
| 24tokhub.com | cnnhi.com | pakistanok.com |
| 24toknow.com | cnnoi.com | peruok.com |
| 24tokpay.com | cnnom.com | philippinesok.com |
| 24toky.com | cnnut.com | polandok.com |
| 24wht.com | cnoad.com | portugalok.com |
| 24wstoken.com | cnocw.com | qakeys.com |
| 24wys.com | cnodo.com | rcjl.com |
| 25hws.com | cnoeo.com | realestatew3.com |
| 26hws.com | cnojo.com | retailw3.com |
| 293.us | cnoma.com | romaniaok.com |
| 2hws.com | cnonl.com | rongcurrency.com |
| 2r888.com | cnopk.com | russianok.com |
| 2u888.com | cnpbs.com | saudiarabiaok.com |
| 365hws.com | cnpet.com | sc888.com |
| 36ji.com | cnphoto.com | show24hrs.com |
| 3r888.com | cnplastics.com | silkusa.com |
| 5888u.com | cnpsb.com | singaporeok.com |
| 638.us | cnptr.com | sinousa.org |
| 6i888.com | cnpwa.com | soulgov.com |
| 6t888.com | cnqcn.com | soulid.us |
| 7888d.com | cnrda.com | soulsdao.com |
| 7888l.com | cnroi.com | soulsid.com |
| 7888t.com | cnrtb.com | spainok.com |
| 7b888.com | cnsaf.com | sundayweb.com |
| 7e888.com | cnsaving.com | swedenok.com |
| 800coin.com | cnsku.com | switzerlandok.com |
| 8881b.com | cnstamps.com | szbf.com |
| 8882v.com | cnstate.com | taiwanok.com |
| 8882w.com | cnsto.com | tdovs.com |
| 8883d.com | cnsuz.com | teknft.com |
| 8883f.com | cnswf.com | termnft.com |
| 8883h.com | cntbx.com | thailandok.com |
| 8883m.com | cntgo.com | thetimeoftime.com |
| 8885d.com | cntive.com | timeag.com |
| 8885l.com | cntok.com | timeage.us |
| 8885u.com | cntokens.com | timeager.com |
| 8886d.com | cntool.com | timecredit.us |
| 8886v.com | cntour.com | timecurrency.us |
| 8887f.com | cntrv.com | timecurreny.com |
| 8887i.com | cntub.com | timecurreny.org |
| 8889f.com | cntvi.com | timecurreny.us |
| 8889m.com | cntvw.com | timenetexchange.com |
| 888a6.com | cnuad.com | timenft.net |
| 888a9.com | cnuce.com | timenft.us |
| 888ad.com | cnufm.com | timeoftime.org |
| 888e9.com | cnuniversity.com | timesoftimes.com |
| 888g2.com | cnuri.com | timesoulcoin.com |
| 888h6.com | cnusg.com | tokendipo.com |
| 888io.com | cnuwb.com | tokmap.com |
| 888oj.com | cnuyu.com | transportw3.com |
| 888ov.com | cnvegas.com | tttus.com |
| 888tx.com | cnvhe.com | tuerbank.com |
| 888uv.com | cnvir.com | tuerchain.com |
| 927.us | cnviu.com | tuercoin.com |
| 9888g.com | cnvly.com | tuercurrency.com |
| 9888i.com | cnvmd.com | tuerpay.com |
| 9888l.com | cnvxp.com | tuertoken.com |
| acup.org | cnwad.com | tuerwallet.com |
| acup.us | cnwalk.com | turkeyok.com |
| acupuncturist.us | cnwbb.com | tycn.com |
| africaw3.com | cnwcm.com | tymeage.com |
| agebank.org | cnwdo.com | u8885.com |
| agebank.us | cnwdr.com | u8889.com |
| agecapital.org | cnwfa.com | uqak.app |
| agechain.org | cnwfw.com | uqak.net |
| agecoin.org | cnwgt.com | uqak.us |
| agecoin.us | cnwhh.com | uqakey.com |
| agecone.com | cnwmt.com | uqakeys.com |
| ageledger.com | cnwoman.com | uqaks.com |
| agesbank.com | cnwsa.com | usaew.com |
| agesystem.org | cnwuxi.com | usahh.com |
| agetime.us | cnwwx.com | usaweb3.com |
| ah888.com | cnwyp.com | usbso.com |
| americanok.com | cnxfm.com | usbuz.com |
| anftid.com | cnyay.com | uscma.com |
| anhuichina.com | cnyhy.com | uscub.com |
| argentinaok.com | cnypg.com | usdal.com |
| arobot.us | cnzcn.com | usdao.com |
| atms.com | cnzyd.com | usdof.com |
| atms.us | coin-dao.com | usdop.com |
| atmscoin.com | com24tokn.com | usdrm.com |
| atmsdao.com | comdaohub.com | usdrw.com |
| australiaok.com | comdaowa.com | useag.com |
| austriaok.com | comdworld.com | usedp.com |
| bangladeshok.com | comw3.com | usedw.com |
| bankmylife.com | crossbordercrypto.com | usehs.com |
| beibanks.com | crownofcoins.com | usenj.com |
| beicurrency.com | cryptoatmdao.com | usfct.com |
| beifr.com | cubaok.com | usfei.com |
| beifurong.com | cyp.us | usfob.com |
| beifurongbank.com | d-agriculture.com | usgws.com |
| beifurongcoin.com | d-economy.com | ushld.com |
| beitoken.com | d-humanity.com | ushst.com |
| belgiumok.com | d-identity.com | usieo.com |
| bioidchain.com | d-infrastructure.com | usiid.com |
| bjzgc.com | d-ipo.com | usiie.com |
| brazilok.com | d-justice.com | usimd.com |
| bulgariaok.com | dainft.com | usimf.com |
| calok.com | daoglob.com | usixx.com |
| canadaok.com | daoled.com | uslei.com |
| carcn.com | daoledg.com | usmoh.com |
| caregiverdao.com | daonft.us | usnfa.com |
| centurynft.com | daosoul.com | usok.com |
| chileok.com | daowelfare.com | usomd.com |
| chinaaids.com | dashibank.com | uspsb.com |
| chinaaluminum.com | dashicurrency.com | usqin.com |
| chinaarchitects.com | dashitoken.com | usqme.com |
| chinaassociations.com | dashiwallet.com | usqol.com |
| chinabrews.com | dauau.com | usrct.com |
| chinacancer.com | days.us | ussfc.com |
| chinaclinics.com | dcloudstorage.com | ussop.com |
| chinacvd.com | ddatasafe.com | usste.com |
| chinadiabetes.com | ddisaster.com | ussts.com |
| chinadiabetic.com | denmarkok.com | usthx.com |
| chinadiagnosis.com | denvironment.com | ustvt.com |
| chinaent.com | dexw3.com | usuai.com |
| chinafurs.com | dgovernance.com | usuns.com |
| chinagrocers.com | dhealthchain.com | ususx.com |
| chinahepatitis.com | diaid.org | usuto.com |
| chinahypertension.com | diaid.us | usver.com |
| chinaimmigration.com | dialogs.us | usvoi.com |
| chinaindexes.com | didms.org | usvov.com |
| chinakeys.com | didms.us | uswds.com |
| chinalifeline.com | dietfood.us | uswok.com |
| chinamedicalcenters.com | dipo.agency | uswwh.com |
| chinanurses.com | dipo.email | uswws.com |
| chinaoncology.com | dipo.it.com | usxbt.com |
| chinaphysician.com | dipo.life | usyan.com |
| chinaradiology.com | dipo.live | usyas.com |
| chinasingleclub.com | dipo.ltd | usyen.com |
| chinasle.com | dipo.network | usyyy.com |
| chinasurgery.com | dipo.services | uz888.com |
| chinatheaters.com | dipo.solutions | vietnamok.com |
| chinausa.org | dipo.world | w32025.com |
| chinavip.org | dipoagency.com | w32030.com |
| chinaxbt.com | dipoapp.com | w32040.com |
| chinaxiamen.com | dipoassets.com | w32100.com |
| chinazhuhai.com | dipobank.com | w3gov.com |
| chinesemedicalclinic.com | dipocapital.com | w3rule.com |
| cn-home.com | dipocredit.com | webwednesday.com |
| cnaaz.com | dipodao.com | week.us |
| cnagt.com | dipoexchange.com | wordlifebank.com |
| cnaiw.com | dipofinance.com | wphysician.com |
| cnaix.com | dipofund.com | wtocn.com |
| cnalf.com | dipoglobal.com | xbady.com |
| cnangels.com | dipoinsurance.com | xclub.us |
| cnantique.com | dipoinvest.com | xiyouji.net |
| cnapply.com | dipolive.com | xlage.com |
| cnayy.com | diponet.com | y8887.com |
| | | years.us |
| | | yencn.com |
| | | yn888.com |
| | | yrs.us |
| | | zgrx.com |
| | | zj888.com |

1. A multi-system, sovereign digital architecture comprising over 800 systemized top-level domain names, wherein each domain represents a distinct category including but not limited to territorial regions, industries, time units, alphabetical indexes, and thematic interests, and wherein each domain serves as an autonomous entry point into a decentralized digital ecosystem governed by smart contracts.

2. The system of claim 1, wherein each top-level domain corresponds to a specific country, regional union, or major global city.

3. The system of claim 1, wherein each top-level domain corresponds to an industry, trade, or professional sector, including but not limited to healthcare, finance, education, logistics, and energy.

4. The system of claim 1, wherein top-level domains are structured by alphabetical index (A-Z), with each letter forming an origin point for personalized naming systems.

5. The system of claim 1, wherein temporal domains include one or more of year, month, week, day, or hour domains, used for time-based registration and identity anchoring.

6. The system of claim 1, wherein interest-based domains enable communities of practice and user-defined verticals to operate as sovereign DAOs.

7. The system of claim 1, further comprising a UsageMeter.sol smart contract to meter usage metrics including but not limited to data access, API calls, and system bandwidth, linked to dynamic token billing.

8. The system of claim 1, wherein all domains are interconnected via TokMapRegistry, enabling cross-domain functional routing and permissionless data transfer.

9. The system of claim 1, wherein subdomains are minted as NFTs (MainDomainTokens) and governed by a decentralized autonomous organization (DAO) smart contract logic.

10. The system of claim 1, wherein ownership of subdomains may be inherited, delegated, or sold, and such ownership is recorded on-chain.

11. A protocol-based resource mapping and token governance system, herein referred to as the TokMap Protocol™, enabling registration, tokenization, subdivision, DAO creation, permission management, and usage metering of digital domains and subdomains, wherein each subdomain is tokenized as a MainDomainToken (MDT) and integrated with NFT and ERC-compatible smart contracts.

12. The system of claim 11, wherein TokMap Protocol™ includes a programmable treasury system that supports multi-party revenue distribution based on usage contribution and token holding.

13. The system of claim 11, wherein each MDT enables creation of a localized DAO with governance rights tied to the parent domain's classification.

14. The system of claim 11, wherein TokMap enables bridging across chains and integration with identity and credentialing standards (e.g., W3C, ENS, etc.)

15. The system of claim 11, wherein each entry point provides sovereign access while enabling cross-domain mirroring via smart contract interlinking.

16. The system of claim 11, wherein categories of usage include domain hosting, data storage, application routing, and identity management.

17. A sovereign user ownership system wherein individuals are not classified as users or subscribers but as permanent digital owners, granted perpetual access to their domains and associated subdomain structures, enabling inheritance, revenue participation, identity registration, and governance rights across territorial, industrial, temporal, alphabetical, and interest-based axes.

18. The system of claim 17, wherein each user may generate and govern an unlimited number of subdomains tied to personal needs, professional activity, or legacy planning.

19. The system of claim 17, wherein MainDomainToken (MDT) ownership is legally recognized as a transferable digital asset subject to inheritance law.

20. The system of claim 17, wherein sovereign owners may represent households, communities, organizations, cities, or nations, each establishing their own federated governance structures.
